(19) United States
(12) Patent Application Publication
(10) Pub. No.: US 2026/0322017 A1
(43) Pub. Date: Oct. 15, 2026

(54) INSERTION CONNECTION DEVICE

(71) Applicant: HEALINNO (BEIJING) MEDICAL TECHNOLOGY CO., LTD., Beijing (CN)

(72) Inventors: YILUN SHI, Beijing (CN); LUJIA SHEN, Beijing (CN); HAO LI, Beijing (CN)

(21) Appl. No.: 19/685,320

(22) Filed: May 22, 2026

Related U.S. Application Data
(63) Continuation of application No. PCT/CN2024/135256, filed on Nov. 28, 2024.

(30) Foreign Application Priority Data
Nov. 28, 2023 (CN) 202311602781.7

(51) Int. Cl. H01R 13/02

(52) U.S. Cl. CPC H01R 13/02

(57) ABSTRACT

The present application provides an insertion connection device including a first unit and a second unit. The first unit has at least three circumferentially spaced fastening jaws. Each jaw's insertion end defines a first jaw surface, a second jaw surface, and first, second, and third edges. A projection of the first edge on a radial cross-section, including its extension, does not pass through the first unit's rotation center. The second unit has a first plug whose insertion end defines a first plug surface, a second plug surface, and a fourth edge. A projection of the fourth edge on a radial cross-section, including its extension, does not pass through the second unit's rotation center. During insertion, the plug is directly inserted into a jaw gap, or the fourth edge slides along jaw edges or surfaces to synchronously rotate the first and/or second unit, enabling convenient blind insertion.

### RELATED APPLICATIONS

The present patent document is a continuation of PCT Application Serial No. PCT/CN2024/135256, filed Nov. 28, 2024, designating the United States and published in English, which is hereby incorporated by reference.

The present patent document claims the benefit of priority to Patent Application No. 202311602781.7, filed Nov. 28, 2023, and entitled “INSERTION CONNECTION DEVICE,” the entire contents of each of which are incorporated herein by reference.

### BACKGROUND

### 1. Technical Field

The present application relates to an insertion connection device capable of facilitating insertion and connection between a driving member and a driven member.

### 2. Background Information

For transmission connection between certain detachable motion components and power sources, for example, end effectors with mechanical motion in medical instruments require disassembly for sterilization treatment or disposal as consumables after each use, whereas power sources incorporating motors, as reusable components, are difficult to sterilize. Under such circumstances, the connection between the motion components and the power sources requires easy assembly and disassembly as well as stable and reliable transmission.

Typically, in such scenarios, a unit incorporating a power source is connected to a unit incorporating a motion component using a housing as a connection reference, and a transmission component is enclosed within the housing due to mechanical safety and sterility requirements. That is, it is required that after two housings are inserted into each other, their internal transmission components can be coupled together. A driving member transmits power stably and reliably to a driven member. In this case, insertion portions of the two parts need to be non-circular (non-cylindrical, non-conical, or the like). Commonly used mechanisms include D-shaped shafts, square shafts, hexagonal shafts, eccentric pins, and the like. All these connection mechanisms can be coupled only when mating surfaces on a male member and a female member are aligned, that is, a driving shaft and a driven shaft must have corresponding circumferential positions for insertion.

When the housings of the two units are connected to each other, the circumferential positions of their respective internal transmission shafts are random, and thus it is difficult for these mechanisms to achieve insertion easily. Particularly, when the housings of the two units contain two or more transmission shafts, an axial positional relationship between each male member and the corresponding female member is required to be one-to-one. This necessitates adjusting the positions of each male member and female member prior to connection, which greatly increases the difficulty of operation and makes blind insertion at any position impossible.

According to existing solutions, one elastic body is provided at a connection end of the driving member or the driven member to allow the connection end to move in an axial direction. After insertion, the elastic body is compressed and the connection end moves axially rearward. When the driving member rotates to a circumferential position where it can be coupled with the driven member, the connection ends of both the driving member and the driven member are coupled under the pushing of the elastic body, achieving the effect of blind insertion. This implementation method involves a relatively complex mechanical structure, which results in a larger mechanism size and increases a failure rate. Moreover, after insertion, it is necessary to first couple each transmission mechanism through the rotation of the driving member, and thus plug-and-play functionality cannot be achieved.

Therefore, in the prior art, how to conveniently achieve the insertion and connection between the driving member and the driven member has become a technical problem.

### BRIEF SUMMARY

An objective of the present application is to provide an insertion connection device capable of facilitating insertion and connection between a driving member and a driven member. To achieve the above objective, a technical solution of the present application is an insertion connection device, which includes a first unit and a second unit connectable to each other in an inserted manner. An insertion direction is defined as an axial direction, a direction perpendicular to the axial direction is defined as a radial direction, a direction of rotation about the axial direction is defined as a circumferential direction, and the first unit and the second unit, which are connected in an inserted manner, are capable of integrally and concentrically rotating in the circumferential direction. The first unit includes at least three fastening jaws distributed at intervals in the circumferential direction and extending axially, each of the at least three fastening jaws having a fastening jaw side surface extending axially. A fastening jaw insertion connection end of each of the at least three fastening jaws for insertion into the second unit includes a first jaw surface and a second jaw surface, the first jaw surface and the second jaw surface intersect to form a first edge, the first jaw surface and the fastening jaw side surface intersect to form a second edge, and the second jaw surface and the fastening jaw side surface intersect to form a third edge. Neither projection of the first edge on a radial cross-section of the first unit nor an extension line thereof passes through a center of rotation of the first unit. The second unit includes a first plug extending axially, a first plug insertion connection end of the first plug for insertion into the first unit includes a first plug surface and a second plug surface, and the first plug surface and the second plug surface intersect to form a fourth edge. The fourth edge extends in a direction intersecting the axial direction, and neither projection of the fourth edge on a radial cross-section of the second unit nor an extension line thereof passes through a center of rotation of the second unit. During an insertion process of the first unit and the second unit, the first plug is directly inserted into a gap between two adjacent fastening jaws of the at least three fastening jaws, or the fourth edge slides along the second edge or the third edge in a direction away from the fastening jaw insertion connection end to synchronously drive the first unit and/or the second unit to rotate, thereby enabling the first plug to enter the gap between two adjacent fastening jaws of the at least three fastening jaws, or the fourth edge slides along the first jaw surface or the second jaw surface in the direction away from the fastening jaw insertion connection end to synchronously drive the first unit and/or the second unit to rotate, thereby enabling the first plug to enter the gap between two adjacent fastening jaws of the at least three fastening jaws.

According to the above technical solution, the first edge and the fourth edge are eccentrically disposed relative to the centers of rotation of their respective units. Regardless of the positions of the first edge and the fourth edge relative to the centers of rotation of their respective units, there is no possibility of axial jamming between the first edge and the fourth edge during insertion. The position and angle arrangement of each jaw surface and each plug surface can convert the axial relative motion of the first unit and the second unit into circumferential relative motion, making the first unit and the second unit easier to rotate in the circumferential direction under stress during insertion, and increasing the success rate of blind insertion.

In a preferred embodiment, a radius of rotation of an end, close to the center of rotation of the first unit, of the first edge of each of the at least three fastening jaws is greater than a radius of rotation of an end, away from the center of rotation of the second unit, of the fourth edge.

According to the above technical solution, since the radius of rotation of the fourth edge is smaller, the fourth edge does not contact the first edge during insertion, avoiding axial jamming against each other.

In a preferred embodiment, a radius of rotation of an end, close to the center of rotation of the first unit, of the first edge of each of the at least three fastening jaws is less than or equal to a radius of rotation of an end, away from the center of rotation of the second unit, of the fourth edge. Each of the at least three fastening jaws and/or the first plug has a predetermined deformation allowance axially and radially. During the insertion process of the first unit and the second unit, when the fourth edge abuts against the first edge of a single fastening jaw of the at least three fastening jaws, the first plug and the fastening jaw, one or both of which have the predetermined deformation allowance, are axially compressed and radially bent, thereby enabling the fourth edge to disengage from the first edge and slide along one of the second edge and the third edge, or enabling the fourth edge to slide along one of the first jaw surface and the second jaw surface.

According to the above technical solution, either the fastening jaw or the first plug, or both, are elastic members and undergo elastic deformation when the first edge abuts against the fourth edge, causing the fourth edge to slide off the first edge and further slide along one of the first jaw surface and the second jaw surface, or one of the second edge and the third edge, in the direction away from the fastening jaw insertion connection end, thereby achieving blind insertion.

In a preferred embodiment, the radius of rotation of the end, close to the center of rotation of the first unit, of the first edge of each of the at least three fastening jaws is greater than or equal to 0.8 times the radius of rotation of the end, away from the center of rotation of the second unit, of the fourth edge.

According to the above technical solution, the probability of axial jamming between the first edge and the second edge can be further reduced.

In a preferred embodiment, the first jaw surface, the second jaw surface, the first plug surface and the second plug surface are inclined faces or curved faces, separately.

According to the above technical solution, each jaw surface and each plug surface may be an inclined surface or a curved surface. The inclined surface is convenient for processing, and the curved surface is easier to achieve the blind insertion effect.

In a preferred embodiment, the first jaw surface and the second jaw surface are inclined surfaces forming a first angle and a second angle with the axial direction, respectively, and/or the first plug surface and the second plug surface are inclined surfaces forming a third angle and a fourth angle with the axial direction, respectively.

According to the above technical solution, the inclination angle of each surface relative to the axial direction can be preset according to experimental debugging conditions to enhance the blind insertion effect.

In a preferred embodiment, the second unit comprises a plug base, and the first plug and a second plug that axially protrude from the same side of the plug base, and a protrusion amount of the second plug from the plug base is less than a protrusion amount of the first plug from the plug base.

According to the above technical solution, the two plugs can make the insertion transmission more stable, and at the same time, the two plugs have different lengths, ensuring that only one plug contacts the fastening jaw insertion connection end at a time during insertion, avoiding an increased probability of jamming caused by simultaneous contact of two plugs with the fastening jaw insertion connection ends.

In a preferred embodiment, a second plug insertion connection end of the second plug for insertion into the first unit comprises a third plug surface and a fourth plug surface, and the third plug surface and the fourth plug surface intersect to form a fifth edge extending in the direction intersecting the axial direction.

According to the above technical solution, the fifth edge is provided to facilitate driving the second unit to rotate under the insertion stress, increasing the success rate of blind insertion.

In a preferred embodiment, during the insertion process of the first unit and the second unit, the second plug is directly inserted into the gap between two adjacent fastening jaws of the at least three fastening jaws, or the fifth edge slides along the second edge or the third edge in a direction away from the fastening jaw insertion connection end to synchronously drive the first unit and/or the second unit to rotate, thereby enabling the second plug to enter the gap between two adjacent fastening jaws of the at least three fastening jaws, or the fifth edge slides along the first jaw surface or the second jaw surface in the direction away from the fastening jaw insertion connection end to synchronously drive the first unit and/or the second unit to rotate, thereby enabling the second plug to enter the gap between two adjacent fastening jaws of the at least three fastening jaws.

According to the above technical solution, the second plug and the first plug cooperate with each other to make blind insertion smoother and transmission more stable.

In a preferred embodiment, the first plug is provided with a first plug notch extending transversely to the axial direction at a portion, away from a connection end, of the first plug in the axial direction, and during the insertion process of the first unit and the second unit, the first plug is subjected to stress from a single fastening jaw of the at least three fastening jaws, and is compressed at the first plug notch, so that the first plug simultaneously undergoes elastic deformation axially and radially.

According to the above technical solution, the plug notch makes the first plug more prone to deformation, thereby making it easier to drive the second unit to rotate and making blind insertion smoother.

In a preferred embodiment, the fastening jaw side surface and/or the second plug surface is an elastic surface, and is compressed to undergo elastic deformation when the first plug is inserted into the at least three fastening jaws.

According to the above technical solution, a gap dimension between two adjacent fastening jaws in a natural state can be slightly smaller than a thickness dimension of the plug. When the plug is inserted into the fastening jaws, the elastic surface is compressed and deformed by the plug and the fastening jaws, so that the plug can enter the gap between two adjacent fastening jaws, and the plug and the fastening jaws are more tightly matched, thereby eliminating the backlash between the plug and the fastening jaws, improving the transmission accuracy, and avoiding vibration during rotation commutation.

### BRIEF DESCRIPTION OF THE DRAWINGS

To more clearly illustrate the present application, the accompanying drawings of the specification will be described and explained below. It is apparent that the drawings described below merely illustrate certain aspects of some exemplary embodiments of the present application. For a person skilled in the art, other drawings may be obtained based on these drawings without creative effort.

FIG. 1 is a schematic view of an insertion state of an insertion connection device.

FIG. 2 is a top view of a first unit.

FIG. 3 is an external view of the first unit.

FIG. 4 is an external view of a second unit.

FIG. 5 is a side view of the second unit.

### REFERENCE NUMERALS IN THE DRAWINGS

100 First unit
101 First fastening jaw
102 Second fastening jaw
103 Third fastening jaw
104 Fourth fastening jaw
1 Fastening jaw insertion connection end
10 First base
11 First jaw surface
111 First edge
112 Second edge
113 Third edge
12 Second jaw surface
13 First side surface
14 Second side surface
200 Second unit
201 First plug
202 Second plug
2 First plug insertion connection end
20 Second base
21 First plug surface
214 Fourth edge
215 Fifth edge
22 Second plug surface
23 Third plug surface
24 Fourth plug surface
3 Second plug insertion connection end

### DETAILED DESCRIPTION OF THE DRAWINGS AND THE PRESENTLY PREFERRED EMBODIMENTS

Various exemplary embodiments of the present application will be described in detail below with reference to the accompanying drawings. The description of the exemplary embodiments is merely illustrative and is not intended to limit the present application and its application or use. The present application may be embodied in many different forms and is not limited to the embodiments set forth herein. These embodiments are provided so that the present application will be thorough and complete, and will fully convey the scope of the present application to a person skilled in the art. It should be noted that the relative arrangements of components and steps, numerical expressions, and numerical values set forth in these embodiments are to be construed as merely exemplary and not limitative, unless otherwise specified.

As used herein, the terms “comprising”, “including”, and similar terms mean that the elements preceding the term encompass the elements recited thereafter, and do not exclude the possibility of encompassing additional elements.

All terms used in the present application (including technical or scientific terms) have the same meaning as commonly understood by a person skilled in the art to which the present application pertains, unless otherwise specifically defined. It should also be understood that terms defined in general dictionaries should be interpreted as having a meaning consistent with their meaning in the context of the relevant art, and should not be interpreted in an idealized or overly formal sense, unless expressly so defined herein.

Components, parameters such as specific models of components, interrelationships between components, and control circuits not described in detail in this section may be considered as techniques, methods, and apparatuses known to a person skilled in the relevant art; however, under appropriate circumstances, such techniques, methods, and apparatuses shall be deemed part of the specification.

### Insertion Connection Device

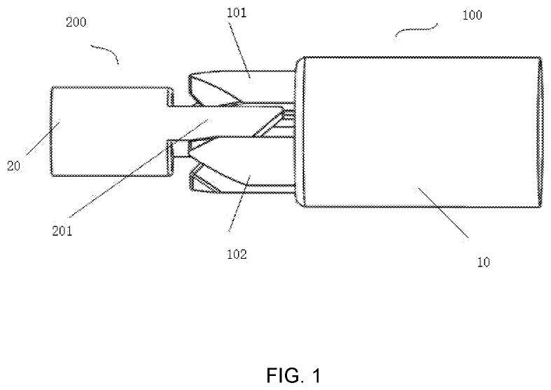

An overall structure of an insertion connection device of the present application will be described below with reference to FIG. 1. FIG. 1 is a schematic view of an insertion state of the insertion connection device.

Referring to FIG. 1, the insertion connection device includes a first unit 100 and a second unit 200 connectable to each other in an inserted manner. For convenience of description, in the present application, an insertion direction of the first unit 100 and the second unit 200 is defined as an axial direction, a direction perpendicular to the axial direction is defined as a radial direction, and a direction of rotation about the axial direction is defined as a circumferential direction.

In a typical application scenario, one of the first unit 100 and the second unit 200 is connected to a power device. After the first unit 100 and the second unit 200 are coupled, the power device can drive the first unit 100 and the second unit 200 to integrally and concentrically rotate in the circumferential direction, thereby realizing power transmission.

To enhance insertion convenience and reduce distraction to an operator during an insertion operation, the insertion connection device is preferably configured as a blind insertion structure. That is, the operator does not need to pay special attention or adjust the first unit 100 or the second unit 200 to a specific alignment state, and can simply pick up either unit and conveniently insert it into the other.

For this purpose, the present application designs the first unit 100 as a fastening jaw structure and the second unit 200 as a plug mechanism, and achieves transmission connection by inserting a plug of the second unit 200 into a fastening jaw gap of the first unit 100.

### First Unit

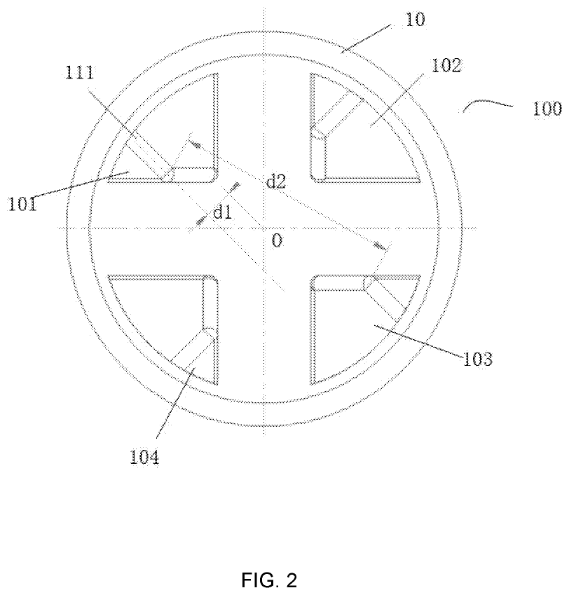

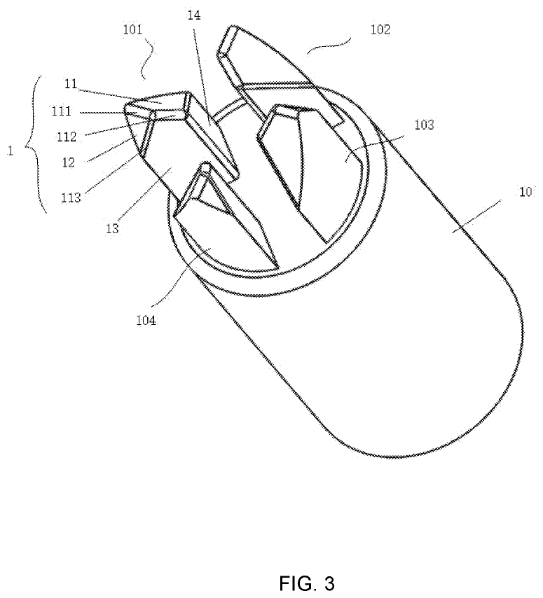

Next, the first unit 100 will be described in detail with reference to FIGS. 2 and 3. FIG. 2 is a top view of the first unit 100, and FIG. 3 is an external view of the first unit 100.

Referring to FIGS. 2 and 3, the first unit 100 includes a first base 10, and at least three fastening jaws distributed at intervals in the circumferential direction and extending axially are provided on one side of the first base 10. For convenience of description, only the illustrated first fastening jaw 101, second fastening jaw 102, third fastening jaw 103 and fourth fastening jaw 104 are taken as examples for description here. In fact, the number of fastening jaws may be 3 or more, which is not specifically limited here.

Preferably, the first fastening jaw 101, the second fastening jaw 102, the third fastening jaw 103 and the fourth fastening jaw 104 have the same size and structural style, and are equally spaced in the circumferential direction for processing and insertion. For simplicity, only the first fastening jaw 101 is described here as an example.

As shown in the figure, the first fastening jaw 101 has a fastening jaw insertion connection end 1 for insertion into the second unit 200, and the fastening jaw insertion connection end 1 is an end, away from the first base 10, of the first fastening jaw 101. The first fastening jaw 101 also has a first side surface 13 as a fastening jaw side surface extending axially, and a second side surface 14 intersecting the first side surface 13 on a radial inner side of the first fastening jaw 101. Preferably, the first side surface 13 and the second side surface 14 are vertical surfaces parallel to the axial direction and perpendicular to the first base 10, but they may also be inclined surfaces forming a certain angle with the axial direction, so that the first fastening jaw 101 presents a style with different thicknesses at both ends, which is not specifically limited here.

The fastening jaw insertion connection end 1 includes a first jaw surface 11 and a second jaw surface 12. The first jaw surface 11 and the second jaw surface 12 may be the illustrated inclined surfaces or curved surfaces, and both conform to the same blind insertion principle. For simplicity, only the case where the first jaw surface 11 and the second jaw surface 12 are inclined surfaces forming a first angle and a second angle with the axial direction, respectively, is described here as an example, and the first angle and the second angle may be the same or different.

The first jaw surface 11 and the second jaw surface 12 intersect to form a first edge 111, the first jaw surface 11 and the first side surface 13 intersect to form a second edge 112, and the second jaw surface 12 and the first side surface 13 intersect to form a third edge 113. At this time, referring to FIG. 2, neither projection of the first edge 111 on a radial cross-section of the first unit 100 nor an extension line thereof passes through a center of rotation O of the first unit 100, that is, the first edge 111 is eccentrically disposed on the radial cross-section, and is offset from the center of rotation O of the first unit 100 by d1.

In this embodiment, the first edge 111 extends in a direction intersecting the axial direction, that is, not parallel to the axial direction. Preferably, the first edge 111 is disposed perpendicular to the axial direction, that is, parallel to the radial cross-section of the first unit 100, but in fact, it is not limited thereto. The first edge 111 may also not be parallel to the radial cross-section, but be disposed in an inclined manner, with one end closer to the first base 10 and the other end farther from the first base 10. For simplicity, only the case where the first edge 111 is perpendicular to the axial direction is described here as an example.

As shown in FIG. 2, the projection of the first edge 111 on the radial cross-section of the first unit 100 is biased toward a side of the fourth fastening jaw 104 relative to the center of rotation O. It can be understood that the projection of the first edge 111 on the radial cross-section may also be biased toward a side of the second fastening jaw 102 relative to the center of rotation O, which is not specifically limited here.

Meanwhile, the eccentric directions of the first edges 111 of different fastening jaws relative to the center of rotation O may be the same or different. For example, the first edge 111 of the first fastening jaw 101 is biased toward the side of the fourth fastening jaw 104 relative to the center of rotation O, while the first edge 111 of the second fastening jaw 102 may be biased toward the side of the first fastening jaw 101 or the side of the third fastening jaw 103 relative to the center of rotation O. In such cases, the structures of different fastening jaws may vary, but the principle of eccentrically disposing the first edge 111 remains consistent, and all such embodiments fall within the scope of protection of the present application.

For simplicity, only the case where the eccentric directions of the first edges 111 of all fastening jaws are the same, i.e., the first edge 111 of the first fastening jaw 101 as illustrated is biased toward the side of the fourth fastening jaw 104 relative to the center of rotation O, is described here as an example.

In the present application, the first fastening jaw 101, the second fastening jaw 102, the third fastening jaw 103, and the fourth fastening jaw 104 may be cut out from a cylindrical base. For example, as illustrated, the first fastening jaw 101 is formed by cutting a cylinder along the first side surface 13 and the second side surface 14. A radially outer side surface of the first fastening jaw 101 that intersects the first side surface 13 and the second side surface 14 constitutes an outer peripheral wall of the cylindrical base. Other fastening jaws may also be conveniently processed in the same way.

### Second Unit

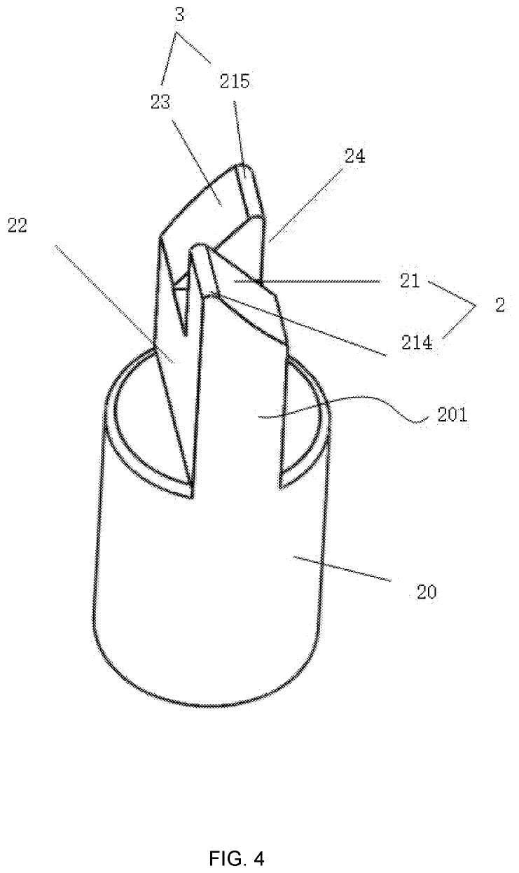

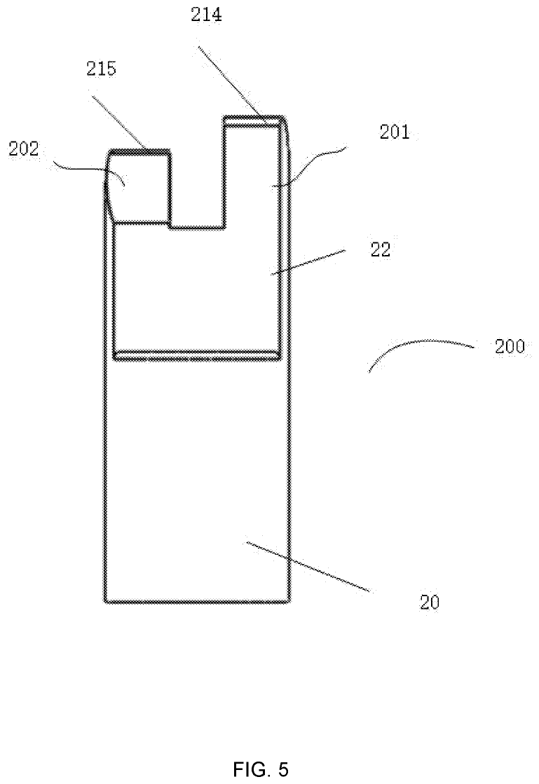

Next, the second unit 200 will be described in detail with reference to FIGS. 4 and 5. FIG. 4 is an external view of the second unit 200, and FIG. 5 is a side view of the second unit 200.

The second unit 200 includes a second base 20 as a plug base, and a first plug 201 extending axially from one side of the second base 20. The first plug 201 has a first plug insertion connection end 2 for insertion into the first unit 100, and the first plug insertion connection end 2 includes a first plug surface 21 and a second plug surface 22. The first plug surface 21 and the second plug surface 22 may be inclined surfaces or curved surfaces, and both conform to the same blind insertion principle. For simplicity, only the case where the first plug surface 21 and the second plug surface 22 are inclined faces forming a third angle and a fourth angle with the axial direction, respectively, is described here as an example, and the third angle and the fourth angle may be the same or different. As a preferred solution, as shown in the figure, the fourth angle is zero, that is, the second plug surface 22 is a vertical surface extending axially and perpendicular to the second base 20. In fact, the fourth angle is not limited thereto, and will not be described in detail here.

The first plug surface 21 and the second plug surface 22 intersect to form a fourth edge 214. The fourth edge 214 extends in the direction intersecting the axial direction, that is, not parallel to the axial direction. Preferably, the fourth edge 214 is disposed perpendicular to the axial direction, that is, parallel to a radial cross-section of the second unit 200, but in fact, it is not limited thereto. The fourth edge 214 may also not be parallel to the radial cross-section, but be disposed in an inclined manner, with one end closer to the second base 20 and the other end farther from the second base 20. For simplicity, only the case where the fourth edge 214 is perpendicular to the axial direction is described here as an example.

At the same time, neither projection of the fourth edge 214 on the radial cross-section of the second unit 200 nor an extension line thereof passes through a center of rotation of the second unit 200, that is, the fourth edge 214 is eccentrically disposed on the radial cross-section.

### Insertion Process

Next, the insertion process will be described in detail.

During the insertion process of the first unit 100 and the second unit 200, the first plug 201 may be directly inserted into a gap between two adjacent fastening jaws of the first fastening jaw 101, the second fastening jaw 102, the third fastening jaw 103 and the fourth fastening jaw 104; alternatively, the fourth edge 214 slides along the second edge 112 or the third edge 113 in a direction away from the fastening jaw insertion connection end 1 and close to the first base 10 to synchronously drive the first unit 100 and/or the second unit 200 to rotate, thereby enabling the first plug 201 to enter the gap between two adjacent fastening jaws; alternatively, the fourth edge 214 slides along the first jaw surface 11 or the second jaw surface 12 in the direction away from the fastening jaw insertion connection end 1 and close to the first base 10 to synchronously drive the first unit 100 and/or the second unit 200 to rotate, thereby enabling the first plug 201 to enter the gap between two adjacent fastening jaws.

Referring to FIG. 2, in Embodiment 1, a radius of rotation of an end, close to the center of rotation O of the first unit 100, of the first edge 111 of each fastening jaw is greater than a radius of rotation of an end, away from the center of rotation of the second unit 200, of the fourth edge 214. The end, close to the center of rotation O of the first unit 100, of the first edge 111 is a radially inner end of the first edge 111, and the radius of rotation of the end is (d2)/2 as shown in the figure, while the end, away from the center of rotation of the second unit 200, of the fourth edge 214 is a radially outer end of the fourth edge 214.

During the insertion process, the second unit 200 is inserted into the first unit 100 in a substantially aligned manner in the axial direction. At this time, the fourth edge 214 may be directly inserted into the gap between the fastening jaws, or may slide into the gap between the fastening jaws along one of the first jaw surface 11 and the second jaw surface 12, or slide into the gap between the fastening jaws along one of the second edge 112 and the third edge 113. Since the radius of rotation of the radially outer end of the fourth edge 214 is smaller than the radius of rotation of the radially inner end of the first edge 111, the fourth edge 214 will not abut against the first edge 111, that is, no axial jamming will occur between the fourth edge 214 and the first edge 111, thereby ensuring smooth insertion and connection between the first unit 100 and the second unit 200.

It can be understood that with the first edge 111 of each fastening jaw eccentrically disposed relative to the center of rotation of the first unit 100 and the fourth edge 214 eccentrically disposed relative to the center of rotation of the second unit 200, during the axial insertion process, when the fourth edge 214 abuts against the first jaw surface 11, the second jaw surface 12, the second edge 112 or the third edge 113, since the first jaw surface 11 and the second jaw surface 12 are inclined surfaces forming a certain angle with the axial direction, and the second edge 112 and the third edge 113 are inclined edges forming a certain angle with the axial direction, the first unit 100 rotates in the circumferential direction under the stress of the fourth edge 214, and the second unit 200 also rotates in the circumferential direction under the stress of the first unit 100, thereby making the first plug 201 easier to insert into the gap between the fastening jaws of the first unit 100 and improving the success rate of blind insertion.

In Embodiment 2, a radius of rotation of an end, close to the center of rotation O of the first unit 100, of the first edge 111 of each fastening jaw is less than or equal to a radius of rotation of an end, away from the center of rotation of the second unit 200, of the fourth edge 214. The end, close to the center of rotation O of the first unit 100, of the first edge 111 is a radially inner end of the first edge 111, and the radius of rotation of the end is (d2)/2 as shown in FIG. 2, while the end, away from the center of rotation of the second unit 200, of the fourth edge 214 is a radially outer end of the fourth edge 214.

During the insertion process, the second unit 200 is inserted into the first unit 100 in a substantially aligned manner in the axial direction. At this time, the fourth edge 214 may be directly inserted into the gap between the fastening jaws, or may slide into the gap between the fastening jaws along one of the first jaw surface 11 and the second jaw surface 12, or slide into the gap between the fastening jaws along one of the second edge 112 and the third edge 113. However, there is also a case where the fourth edge 214 abuts against the first edge 111. When the two abut against each other, the fourth edge 214 and the first edge 111 are prone to axial jamming against each other, making it impossible for the first unit 100 and the second unit 200 to be inserted smoothly.

For this reason, as a preferred solution, the first fastening jaw 101, the second fastening jaw 102, the third fastening jaw 103, the fourth fastening jaw 104 and/or the first plug 201 have a predetermined deformation allowance axially and radially. That is, at least one of the first plug 201 and the fastening jaws of the first unit 100 (including the first fastening jaw 101, the second fastening jaw 102, the third fastening jaw 103 and the fourth fastening jaw 104) is an elastic member.

The case where only the fastening jaw is an elastic member is described here as an example. During the insertion process of the first unit 100 and the second unit 200, if the fourth edge 214 abuts against the first edge 111 of the first fastening jaw 101, the first fastening jaw 101 will be axially compressed under the stress of the fourth edge 214. At this point, since the first edge 111 is eccentrically disposed toward a side of the fourth fastening jaw 104, the first fastening jaw 101 will also bend radially. Specifically, the first jaw surface 11 will be bent and stretched toward the fourth fastening jaw 104, so that under the deformation stress of the first fastening jaw 101, the first unit 100 will rotate counterclockwise in a direction from the first fastening jaw 101 toward the fourth fastening jaw 104. Furthermore, with the rotation of the first unit 100, the fourth edge 214 of the first plug 201 is disengaged from the first edge 111, and then slides along one of the second edge 112 and the third edge 113, or along one of the first jaw surface 11 and the second jaw surface 12, and finally slides into the gap between the fastening jaws, realizing the insertion and connection between of the first unit 100 and the second unit 200.

It can be understood that with the first edge 111 of each fastening jaw eccentrically disposed relative to the center of rotation of the first unit 100 and the fourth edge 214 eccentrically disposed relative to the center of rotation of the second unit 200, during the axial insertion process, when the fourth edge 214 disengages from the first edge 111 and then abuts against the first jaw surface 11, the second jaw surface 12, the second edge 112 or the third edge 113, since the first jaw surface 11 and the second jaw surface 12 are inclined surfaces forming a certain angle with the axial direction, and the second edge 112 and the third edge 113 are inclined edges forming a certain angle with the axial direction, the first unit 100 rotates in the circumferential direction under the stress of the fourth edge 214, and the second unit 200 also rotates in the circumferential direction under the stress of the first unit 100, thereby making the first plug 201 easier to insert into the gap between the fastening jaws of the first unit 100.

As a preferred solution, the fastening jaws of the first unit 100 and the first plug 201 of the second unit 200 both have a predetermined deformation allowance axially and radially. In this way, when the fourth edge 214 abuts against the first edge 111, the first plug 201 is also axially compressed and radially bent under the stress of the first edge 111, thereby driving the second unit 200 to rotate, making the first plug 201 easier to insert into the gap between the fastening jaws of the first unit 100.

Combining the foregoing Embodiment 1 and Embodiment 2, in order to ensure the success rate of blind insertion, based on experimental data, as a preferred solution, the radius of rotation of the end, close to the center of rotation of the first unit 100, of the first edge 111 of each fastening jaw is greater than or equal to 0.8 times the radius of rotation of the end, away from the center of rotation of the second unit 200, of the fourth edge 214.

In addition, preferably, in the insertion state, the projections of the first edge 111 of each fastening jaw and the fourth edge 214 of the first plug 201 on the radial cross-section are not parallel. In this way, during the insertion process, when the first edge 111 and the fourth edge 214 abut against each other, only staggered point contact occurs, rather than coincident line contact, making it easier for the fourth edge 214 to slide off and disengage from the first edge 111. At the same time, an inclination direction of the first plug surface 21 and inclination directions of the first jaw surface 11 and second jaw surface 12 are also inconsistent, avoiding the case where the first plug surface 21 is in face contact with the first jaw surface 11 and the second jaw surface 12, which would increase the frictional resistance.

### Second Plug

Next, a second plug 202 will be described with reference to FIGS. 4 and 5.

Referring to FIGS. 4 and 5, the second plug 202 also extends axially from the same side of the second base 20 where the first plug 201 is connected. Preferably, the second plug 202 is disposed parallel to the first plug 201 and is radially spaced apart from the first plug 201.

The second plug 202 has a second plug insertion connection end 3 for insertion into the first unit 100, and the second plug insertion connection end 3 includes a third plug surface 23 and a fourth plug surface 24. The third plug surface 23 and the fourth plug surface 24 may be inclined surfaces or curved surfaces, and both conform to the same blind insertion principle. For simplicity, only the case where the third plug surface 23 and the fourth plug surface 24 are inclined surfaces forming a fifth angle and a sixth angle with the axial direction, respectively, is described here as an example, and the fifth angle and the sixth angle may be the same or different. As a preferred solution, as shown in the figure, the sixth angle is zero, that is, the fourth plug surface 24 is a vertical surface extending axially and perpendicular to the second base 20. In fact, the sixth angle is not limited thereto, and will not be described in detail here. In an axial cross-section of FIG. 5, the second plug surface 22 traverses the entire second unit 200, with one part serving as a side surface of the first plug 201 and the other part serving as a side surface of the second plug 202. Similarly, the fourth plug surface 24 is disposed opposite the second plug surface 22, and traverses the entire second unit 200 in the axial cross-section of FIG. 5. One part of the fourth plug surface 24 serves as the side surface of the second plug 202 and the other part of the fourth plug surface 24 serves as the side surface of the first plug 201. In other words, it is equivalent to cutting out the second plug surface 22 and the fourth plug surface 24 in the axial direction with two planes on a cylinder where the second base 20 is located, which will not be described in detail here.

The third plug surface 23 and the fourth plug surface 24 intersect to form a fifth edge 215. The fifth edge 215 extends in the direction intersecting the axial direction, that is, not parallel to the axial direction. Preferably, the fifth edge 215 is disposed perpendicular to the axial direction, that is, parallel to the radial cross-section of the second unit 200, but in fact, it is not limited thereto. The fifth edge 215 may also not be parallel to the radial cross-section, but be disposed in an inclined manner, with one end closer to the second base 20 and the other end farther from the second base 20. For simplicity, only the case where the fifth edge 215 is perpendicular to the axial direction is described here as an example.

Further preferably, neither projection of the fifth edge 215 on the radial cross-section of the second unit 200 nor an extension line thereof passes through the center of rotation of the second unit 200, that is, the fifth edge 215 is eccentrically disposed on the radial cross-section. Thus, during the insertion process, the second unit 200 is more prone to rotation under the stress of the fifth edge 215, so as to reduce the probability of axial jamming between the fifth edge 215 and the first edge 111 of the fastening jaw. It should be noted that the fifth edge 215 may also not be eccentrically disposed, as the first plug 201 has been inserted between the fastening jaws first and drives the first unit 100/second unit 200 to rotate, and the fifth edge 215 can be inserted between the fastening jaws of the first unit 100 even if it is not eccentrically disposed, which will not be described in detail here.

As a preferred solution, a protrusion amount of the second plug 202 from the second base 20 is less than a protrusion amount of the first plug 201 from the plug base 20, that is, the second plug 202 is shorter in the axial direction than the first plug 201. In this way, during the insertion process, the first plug 201 reaches the fastening jaws of the first unit 100 earlier than the second plug 202, and the fourth edge 214 first contacts the fastening jaw insertion connection end 1 of one of the fastening jaws. After the first plug 201 is inserted a certain distance in the axial direction toward the first base 10, the second plug 202 reaches the fastening jaws of the first unit 100, and the fifth edge 215 starts to contact the fastening jaw insertion connection end 1 of another fastening jaw. This can avoid the increase in the probability of axial jamming between the first unit 100 and the second unit 200 caused by the simultaneous contact of the fourth edge 214 and the fifth edge 215 with the fastening jaw insertion connection ends 1 of two respective fastening jaws. In this way, while ensuring the success rate of blind insertion, the arrangement of the two plugs makes the insertion and connection between the first unit 100 and the second unit 200 tighter and the transmission effect more stable.

Preferably, the first plug 201 and the second plug 202 are symmetrically disposed in the radial direction. For example, when the first plug 201 is inserted into a gap between the first fastening jaw 101 and the fourth fastening jaw 104, the second plug 202 is correspondingly inserted into a gap between the second fastening jaw 102 and the third fastening jaw 103.

At the same time, an axial dimension difference between the first plug 201 and the second plug 202 can be reasonably designed. When the dimension difference is large, the second plug 202 reaches the position of the fastening jaw insertion connection end 1 of another fastening jaw only after the first plug 201 slides off the first jaw surface 11, the second jaw surface 12, the second edge 112 or the third edge 113 and enters the gap between the fastening jaws. Since the first plug 201 has entered the gap between the fastening jaws, the second plug 202 is correspondingly inserted into the symmetrical fastening jaw gap.

However, as a preferred solution, the dimension difference is designed to be relatively small. Before the first plug 201 slides off the first jaw surface 11, the second jaw surface 12, the second edge 112 or the third edge 113 of one of the fastening jaws, the second plug insertion connection end 3 of the second plug 202 starts to contact the fastening jaw insertion connection end 1 of another fastening jaw. For example, when the first plug 201 slides a certain distance on the first jaw surface 11 of the first fastening jaw 101 and has not slid off, the second plug 202 starts to slide on the corresponding jaw surface of the third fastening jaw 103. In this way, the first plug 201 and the second plug 202 apply a rotational force to the first unit 100 in the same direction, making the first unit 100 and the second unit 200 easier to rotate relative to each other, thereby improving the convenience and success rate of blind insertion.

During the insertion process, the principle of the second plug 202 being inserted into the first unit 100 is the same as that of the first plug 20.

Specifically, in the foregoing Embodiment 1, a radius of rotation of an end, close to the center of rotation O of the first unit 100, of the first edge 111 of each fastening jaw is greater than a radius of rotation of an end, away from the center of rotation of the second unit 200, of the fifth edge 215. The end, away from the center of rotation of the second unit 200, of the fifth edge 215 is a radially outer end of the fifth edge 215.

During the insertion process, the fifth edge 215 may be directly inserted into the gap between the fastening jaws, or may slide into the gap between the fastening jaws along one of the first jaw surface 11 and the second jaw surface 12, or slide into the gap between the fastening jaws along one of the second edge 112 and the third edge 113. Since the radius of rotation of the radially outer end of the fifth edge 215 is smaller than the radius of rotation of the radially inner end of the first edge 111, the fifth edge 215 will not abut against the first edge 111, that is, no axial jamming will occur between the fifth edge 215 and the first edge 111, thereby ensuring smooth insertion and connection between the first unit 100 and the second unit 200.

It can be understood that with the first edge 111 eccentrically disposed relative to the center of rotation of the first unit 100 and the fifth edge 215 eccentrically disposed relative to the center of rotation of the second unit 200, during the axial insertion process, when the fifth edge 215 abuts against the first jaw surface 11, the second jaw surface 12, the second edge 112 or the third edge 113, since the first jaw surface 11 and the second jaw surface 12 are inclined surfaces forming a certain angle with the axial direction, and the second edge 112 and the third edge 113 are inclined edges forming a certain angle with the axial direction, the first unit 100 rotates in the circumferential direction under the stress of the fifth edge 215, and the second unit 200 also rotates in the circumferential direction under the stress of the first unit 100, thereby making the second plug 202 easier to insert into the gap between the fastening jaws.

In the foregoing Embodiment 2, a radius of rotation of an end, close to the center of rotation O of the first unit 100, of the first edge 111 of each fastening jaw is less than or equal to a radius of rotation of an end, away from the center of rotation of the second unit 200, of the fifth edge 215.

During the insertion process, the second unit 200 is inserted into the first unit 100 in the axial direction. At this time, the fifth edge 215 may be directly inserted into the gap between the fastening jaws, or may slide into the gap between the fastening jaws along one of the first jaw surface 11 and the second jaw surface 12, or slide into the gap between the fastening jaws along one of the second edge 112 and the third edge 113. However, there is also a possibility that the fifth edge 215 abuts against the first edge 111. When the two abut against each other, the fifth edge 215 and the first edge 111 are prone to axial jamming against each other.

For this reason, as a preferred solution, the first fastening jaw 101, the second fastening jaw 102, the third fastening jaw 103, the fourth fastening jaw 104 and/or the second plug 202 have a predetermined deformation allowance axially and radially. That is, at least one of the second plug 202 and the fastening jaws of the first unit 100 (including the first fastening jaw 101, the second fastening jaw 102, the third fastening jaw 103 and the fourth fastening jaw 104) is an elastic member.

Similar to the principle of the first plug 201, when the second plug 202 is an elastic member, the stress when the fifth edge 215 abuts against the first edge 111 causes the second plug 202 to be axially compressed and radially bent, thereby driving the second base 20 to rotate, making the fifth edge 215 disengage from the first edge 111, and causes the second plug 202 to slide along one of the second edge 112 and the third edge 113, or along one of the first jaw surface 11 and the second jaw surface 12, and finally slide into the gap between the fastening jaws.

Combining the foregoing Embodiment 1 and Embodiment 2, in order to ensure the success rate of blind insertion, based on experimental data, as a preferred solution, the radius of rotation of the end, close to the center of rotation of the first unit 100, of the first edge 111 of each fastening jaw is greater than or equal to 0.8 times the radius of rotation of the end, away from the center of rotation of the second unit 200, of the fifth edge 215.

### Plug Notch

As a preferred embodiment, a first plug notch (not shown in the figure) extending transversely to the axial direction is provided at a portion, axially close to the second base 20, of the first plug 201. The first plug notch is a structure opening to one lateral side of the first plug 201.

During the insertion process of the first unit 100 and the second unit 200, when the first plug 201 is subjected to stress from the fastening jaw insertion connection end 1, compression occurs at the first plug notch, so that the first plug 201 is simultaneously compressed in the axial direction and bent in the radial direction, thereby making the second base 20 rotate in the circumferential direction under the deformation stress of the first plug 201, and making the first plug 201 easier to insert into the gap between the fastening jaws of the first unit 100.

Similarly, as a preferred embodiment, a second plug notch (not shown in the figure) extending transversely to the axial direction is also provided at a portion, axially close to the second base 20, of the second plug 202. The structure of the second plug notch and the principle during insertion are the same as those of the first plug notch, which will not be described in detail here.

### Plug Thickness and Fastening Jaw Gap

Since the first plug 201 and the second plug 202 need to be inserted into the gap between any two adjacent fastening jaws in the first unit 100, generally speaking, a gap dimension between two adjacent fastening jaws needs to be larger than thickness dimensions of the first plug 201 and the second plug 202, that is, there is a backlash between the plug and the fastening jaw in the insertion state.

Here, the thickness dimension of the plug refers to a dimension of the plug in the radial direction, and in this embodiment, specifically refers to a dimension of the first plug 201 in a direction perpendicular to the second plug surface 22, and a dimension of the second plug 202 in a direction perpendicular to the fourth plug surface 24. Preferably, the thickness dimensions of the first plug 201 and the second plug 202 are the same, that is, the distance between the second plug surface 22 and the fourth plug surface 24 as shown in the figure.

When the thickness dimension of the plug is larger than the gap dimension between two adjacent fastening jaws, generally, the plug cannot be inserted into the gap between the fastening jaws. However, for application scenarios with high transmission accuracy requirements, such as surgical robots, the backlash between the plug and the fastening jaw will affect the motion control accuracy of the entire transmission mechanism. For application scenarios involving high-speed operation and reciprocating rotation, when the rotation is commutated, this backlash will induce mechanical vibration, generate additional noise and affect the life of the mechanism.

For this reason, as a preferred solution, the present application configures at least one of the first side surface 13 and the second side surface 14 of each fastening jaw, and/or at least one of the second plug surface 22 and the fourth plug surface 24 as a surface with an elastic body, that is, the surface can elastically deform in the radial direction. Thus, the gap dimension between two adjacent fastening jaws in a natural state can be slightly smaller than the thickness dimensions of the first plug 201 and the second plug 202. After any plug is inserted into the gap between two adjacent fastening jaws, the surface with the elastic body is compressed and deformed due to extrusion, so that the plug can be smoothly inserted between two adjacent fastening jaws, and the backlash between the plug and the fastening jaw can be eliminated, thereby improving the transmission accuracy and eliminating the vibration generated during high-speed commutation.

As another preferred solution, at least one of the first side surface 13 and the second side surface 14 of each fastening jaw, and/or at least one of the second plug surface 22 and the fourth plug surface 24 is configured as an inclined surface. Specifically, at least one of the first side surface 13 and the second side surface 14 of each fastening jaw may be configured as an inclined surface that slopes increasingly in a direction away from the center of rotation of the first unit 100 as it gets farther from the first base 10, so that the gap between two adjacent fastening jaws is configured in a manner where the gap dimension increases as it gets farther from the first base 10. And/or, at least one of the second plug surface 22 and the fourth plug surface 24 may also be configured as an inclined surface that slopes increasingly in a direction away from the center of rotation of the second unit 200 as it gets farther from the second base 20, so that the first plug 201 and the second plug 202 are configured to become progressively more tapered as they are farther from the second base 20.

Furthermore, the gap between two adjacent fastening jaws farther from the first base 10 is slightly larger than the thickness dimensions of the ends of the first plug 201 and the second plug 202 farther from the second base 20, but the gap between two adjacent fastening jaws close to the first base 10 is slightly smaller than the thickness dimensions of the ends of the first plug 201 and the second plug 202 farther from the second base 20. During insertion, the first plug 201 and the second plug 202 are inserted into the gap between two adjacent fastening jaws like wedges, realizing tight fit between the two and eliminating backlash.

In summary, in the present application, the first edge 111 and the fourth edge 214 are both eccentrically disposed relative to their respective centers of rotation, so that under the stress during insertion, they are easier to drive their respective first unit 100 and the second unit 200 to rotate, thereby increasing the success rate of blind insertion. During the insertion process, the operator does not need to pay special attention, nor does he/she need to specially align the first unit 100 and the second unit 200 in the axial direction or adjust one of them to a predetermined angle in the circumferential direction, and can conveniently achieve the insertion operation.

Further, the radius of rotation of the radially inner end of the first edge 111 is made larger than the radius of rotation of the radially outer end of the fourth edge 214, avoiding axial jamming between the first edge 111 and the fourth edge 214. Alternatively, the fastening jaws of the first unit 100 and/or the first plug 201 are configured as elastic members. When the first edge 111 and the fourth edge 214 abut against each other, the fastening jaws and/or the first plug 201 are axially compressed and radially bent, thereby making the first unit 100 and/or the second unit 200 rotate under the deformation stress, avoiding axial jamming.

In other words, in the present application, a plurality of special surfaces and edges are respectively provided at the connection ends of the driving shaft and the driven shaft. These surfaces and edges are asymmetrically arranged, and can convert axial relative motion into circumferential relative rotation at any circumferential position of each shaft, that is, convert the axial insertion force during insertion into circumferential rotational motion until the two shafts are coupled together. The insertion connection device of the present application features small size, high reliability, blind insertion capability without redundant operations or additional tools, convenient insertion and removal, and stable and reliable transmission, can be conveniently used in occasions with sterile requirements in the medical field, and has low dependence on operators. In particular, when a plurality of driving shafts and driven shafts that need to be in transmission connection with each other are involved, the structure of the present application can also conveniently achieve the effect of blind insertion between the plurality of shafts.

It should be understood that the specific embodiments described above are provided for illustrative purposes only, and the scope of protection of the present application is not limited thereto. Any modifications, substitutions, and combinations made by a person skilled in the art based on the technical solutions and inventive concept of the present application within the technical scope disclosed in the present application shall fall within the scope of protection of the present application.

1. An insertion connection device comprising:
a first unit and a second unit connectable to each other in an inserted manner, wherein an insertion direction is defined as an axial direction, a direction perpendicular to the axial direction is defined as a radial direction, a direction of rotation about the axial direction is defined as a circumferential direction, and the first unit and the second unit, which are connected in an inserted manner, are capable of integrally and concentrically rotating in the circumferential direction,
the first unit comprises at least three fastening jaws distributed at intervals in the circumferential direction and extending axially, each of the at least three fastening jaws having a fastening jaw side surface extending axially,
a fastening jaw insertion connection end of each of the at least three fastening jaws for insertion into the second unit comprises a first jaw surface and a second jaw surface, the first jaw surface and the second jaw surface intersect to form a first edge, the first jaw surface and the fastening jaw side surface intersect to form a second edge, and the second jaw surface and the fastening jaw side surface intersect to form a third edge,
neither projection of the first edge on a radial cross-section of the first unit nor an extension line thereof passes through a center of rotation of the first unit,
the second unit comprises a first plug extending axially, a first plug insertion connection end of the first plug for insertion into the first unit comprises a first plug surface and a second plug surface, and the first plug surface and the second plug surface intersect to form a fourth edge,
the fourth edge extends in a direction intersecting the axial direction, and neither projection of the fourth edge on a radial cross-section of the second unit nor an extension line thereof passes through a center of rotation of the second unit,
during an insertion process of the first unit and the second unit, the first plug is directly inserted into a gap between two adjacent fastening jaws of the at least three fastening jaws, or
the fourth edge slides along the second edge or the third edge in a direction away from the fastening jaw insertion connection end to synchronously drive the first unit and/or the second unit to rotate, thereby enabling the first plug to enter the gap between two adjacent fastening jaws of the at least three fastening jaws, or
the fourth edge slides along the first jaw surface or the second jaw surface in the direction away from the fastening jaw insertion connection end to synchronously drive the first unit and/or the second unit to rotate, thereby enabling the first plug to enter the gap between two adjacent fastening jaws of the at least three fastening jaws.

2. The insertion connection device according to claim 1, wherein
a radius of rotation of an end, close to the center of rotation of the first unit, of the first edge of each of the at least three fastening jaws is greater than a radius of rotation of an end, away from the center of rotation of the second unit, of the fourth edge.

3. The insertion connection device according to claim 1, wherein
a radius of rotation of an end, close to the center of rotation of the first unit, of the first edge of each of the at least three fastening jaws is less than or equal to a radius of rotation of an end, away from the center of rotation of the second unit, of the fourth edge,
each of the at least three fastening jaws and/or the first plug has a predetermined deformation allowance axially and radially, and
during the insertion process of the first unit and the second unit, when the fourth edge abuts against the first edge of a single fastening jaw of the at least three fastening jaws, the first plug and the fastening jaw, one or both of which have the predetermined deformation allowance, are axially compressed and radially bent, thereby enabling the fourth edge to disengage from the first edge and slide along one of the second edge and the third edge, or enabling the fourth edge to slide along one of the first jaw surface and the second jaw surface.

4. The insertion connection device according to claim 3, wherein
the radius of rotation of the end, close to the center of rotation of the first unit, of the first edge of each of the at least three fastening jaws is greater than or equal to 0.8 times the radius of rotation of the end, away from the center of rotation of the second unit, of the fourth edge.

5. The insertion connection device according to claim 1, wherein
the first jaw surface, the second jaw surface, the first plug surface and the second plug surface are inclined surfaces or curved surfaces, separately.

6. The insertion connection device according to claim 5, wherein
the first jaw surface and the second jaw surface are inclined surfaces forming a first angle and a second angle with the axial direction, respectively, and/or
the first plug surface and the second plug surface are inclined surfaces forming a third angle and a fourth angle with the axial direction, respectively.

7. The insertion connection device according to claim 1, wherein
the second unit comprises a plug base, and the first plug and a second plug that axially protrude from the same side of the plug base, and a protrusion amount of the second plug from the plug base is less than a protrusion amount of the first plug from the plug base.

8. The insertion connection device according to claim 7, wherein
a second plug insertion connection end of the second plug for insertion into the first unit comprises a third plug surface and a fourth plug surface, and the third plug surface and the fourth plug surface intersect to form a fifth edge extending in the direction intersecting the axial direction.

9. The insertion connection device according to claim 8, wherein
during the insertion process of the first unit and the second unit, the second plug is directly inserted into the gap between two adjacent fastening jaws of the at least three fastening jaws, or
the fifth edge slides along the second edge or the third edge in a direction away from the fastening jaw insertion connection end to synchronously drive the first unit and/or the second unit to rotate, thereby enabling the second plug to enter the gap between two adjacent fastening jaws of the at least three fastening jaws, or
the fifth edge slides along the first jaw surface or the second jaw surface in the direction away from the fastening jaw insertion connection end to synchronously drive the first unit and/or the second unit to rotate, thereby enabling the second plug to enter the gap between two adjacent fastening jaws of the at least three fastening jaws.

10. The insertion connection device according to claim 1, wherein
the first plug is provided with a first plug notch extending transversely to the axial direction at a portion, away from a connection end, of the first plug in the axial direction, and
during the insertion process of the first unit and the second unit, the first plug is subjected to stress from a single fastening jaw of the at least three fastening jaws, and is compressed at the first plug notch, so that the first plug simultaneously undergoes elastic deformation axially and radially.

11. The insertion connection device according to claim 1, wherein
the fastening jaw side surface and/or the second plug surface is an elastic surface, and is compressed to undergo elastic deformation when the first plug is inserted into the at least three fastening jaws.
